(19) United States
(12) Patent Application Publication
(10) Pub. No.: US 2021/0176271 A1
(43) Pub. Date: Jun. 10, 2021

(54) NON-TRANSITORY COMPUTER-READABLE STORAGE MEDIUM, MALWARE INSPECTION SUPPORT METHOD, AND COMMUNICATION DEVICE

(71) Applicant: FUJITSU LIMITED, Kawasaki-shi (JP)

(72) Inventor: Kunihiko Yoshimura, Katsushika (JP)

(73) Assignee: FUJITSU LIMITED, Kawasaki-shi (JP)

(21) Appl. No.: 17/101,293

(22) Filed: Nov. 23, 2020

(30) Foreign Application Priority Data
Dec. 9, 2019 (JP) 2019-222168

(51) Int. Cl. H04L 29/06

(52) U.S. Cl. CPC H04L 63/1458; H04L 63/145; H04L 63/1416

(57) ABSTRACT

A non-transitory computer-readable storage medium storing a generation program that causes a processor to execute a process. The process includes, when malware is detected in a first processing device belonging to a first system, changing a destination address of packets transmitted from the first processing device to an address corresponding to a second processing device belonging to a second system based on a predetermined rule to transmit the packets to the second processing device that belongs to the second system, executing a generation process that, based on log information generated in the first system, generate at least one of a fake file of a file related to the first system, a fake email of an email related to the first system, or fake communication information of communication information related to the first system, and transmitting the generated fake file or fake communication information to the second processing device.

### CROSS-REFERENCE TO RELATED APPLICATION

This application is based upon and claims the benefit of priority of the prior Japanese Patent Application No. 2019-222168, filed on Dec. 9, 2019, the entire contents of which are incorporated herein by reference.

### FIELD

The embodiments discussed herein are related to a non-transitory computer-readable storage medium, a malware inspection support method, and a communication device.

### BACKGROUND

In recent years, cyber-attacks such as unauthorized access through a network have become a serious problem. In order to deal with the cyber-attacks, it is important to observe the cyber-attacks and collect cyber threat intelligence (CTI) that summarizes the attacker, purpose, attack method, tactics, and the like, in a report and the like. As a related art for collecting the CTI, an unauthorized access-information system has been known in which a malicious program is allowed to operate, and unauthorized access to a honeynet, which is a simulated environment built to observe the behavior and attack method of malicious programs, is monitored to collect unauthorized access information.

Related techniques are disclosed in for example International Publication Pamphlet No. WO 2016/42587 is disclosed as related art.

### SUMMARY

According to an aspect of the embodiments, a non-transitory computer-readable storage medium storing a generation program that causes a processor to execute a process, the process includes: when malware is detected in a first information processing device that belongs to a first system, changing a destination address of packets transmitted from the first information processing device to an address corresponding to a second information processing device that belongs to a second system based on a predetermined rule to transmit the packets to the second information processing device that belongs to the second system; executing a generation process that, based on log information generated in the first system, generate at least one of a fake file of a file related to the first system, a fake email of an email related to the first system, or fake communication information of communication information related to the first system; and transmitting the generated fake file or fake communication information to the second information processing device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram for explaining a configuration example of a system;

FIG. 2 is a block diagram exemplifying a functional configuration of a communication device according to an embodiment;

FIG. 3 is a flowchart illustrating an operation example of the communication device according to the embodiment;

FIG. 4 is an explanatory diagram for explaining communication in a normal mode;

FIG. 5 is an explanatory diagram for explaining communication in a deception mode;

FIG. 6 is a flowchart illustrating an operation example in the deception mode;

FIG. 7A is a flowchart illustrating an example of deceptive communication in the deception mode;

FIG. 7B is a flowchart illustrating an example of deceptive communication in the deception mode;

FIG. 7C is a flowchart illustrating an example of deceptive communication in the deception mode;

FIG. 8 is an explanatory diagram for explaining deceptive communication in the deception mode; and

FIG. 9 is a block diagram illustrating a hardware configuration example of an information processing device according to the embodiment.

### DESCRIPTION OF EMBODIMENTS

In the related art, in a honeynet, communication such as file transmission and email transmission simulating normal work by humans does not occur. For this reason, there is a problem that an attacker may notice that he/she is being observed on the honeynet.

For example, if an attacker notices that he/she is being observed on the honeynet, he/she will interrupt the attack, making it difficult to continuously and safely collect unauthorized access information.

In one aspect, it is an object to provide a malware inspection support program, a malware inspection support method, and a communication device capable of supporting safe transmission of unauthorized access information to the CTI.

Hereinafter, a malware inspection support program, a malware inspection support method, and a communication device according to an embodiment will be described with reference to the drawings. Configurations with the same functions in the embodiments are denoted by the same reference signs, and redundant description will be omitted. Note that the malware inspection support program, the malware inspection support method, and the communication device described in the following embodiments are merely examples and do not limit the embodiments. Additionally, each of the embodiments below may be appropriately combined unless otherwise contradicted.

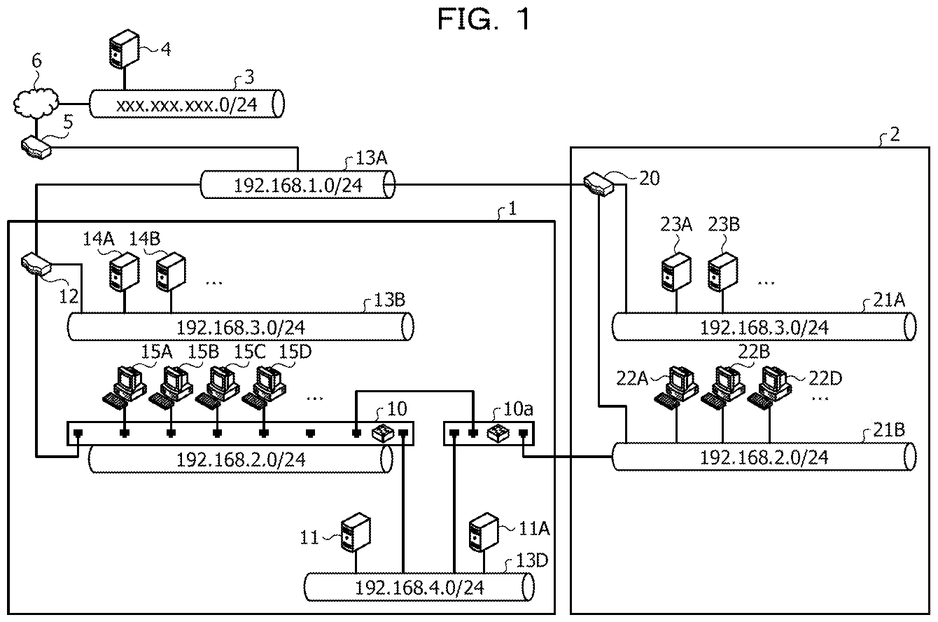

FIG. 1 is an explanatory diagram for explaining a configuration example of a system. As illustrated in FIG. 1, the system of the embodiment has a corporate network system 1 of a company and the like, and a honey network system 2 imitating the network configuration of the corporate network system 1. The corporate network system 1 is an example of a first system, and the honey network system 2 is an example of a second system.

The corporate network system 1 connects to an external network 3 having a classless inter-domain routing (CIDR) notation “xxx.xxx.xxx.0/24”, for example, through a network address translation (NAT) router 5 and an Internet 6. The external network 3 has, for example, a C&C server 4 which plays a role of issuing a command to a terminal in the corporate network system 1 infected with malware, and controlling the terminal.

The corporate network system 1 has an OpenFlow switch 10, an OpenFlow controller 11, a storage device 11A, a NAT router 12, servers 14A, 14B . . . , and terminals 15A, 15B, 15C . . . .

The OpenFlow switches 10 and 10a are network switches that relay and transfer data between devices connected to ports under the control of the OpenFlow controller 11, and are examples of communication devices. Note that in the following description, the OpenFlow switches 10 and 10a may be referred to as the OpenFlow switch 10 unless otherwise specified. The OpenFlow controller 11 uses the OpenFlow protocol to deliver, to the OpenFlow switch 10, a flow table related to route control such as operation for packets under a predetermined condition, and sets the flow table. The storage device 11A stores various types of information such as the flow table for route control.

The flow table that the OpenFlow controller 11 delivers to the OpenFlow switch 10 and sets is created by settings of a network administrator of the corporate network system 1, and is stored in the storage device 11A. The flow table shows actions such as passing or blocking of packets, rewriting of media access control (MAC) addresses and internet protocol (IP) addresses, and changing of output ports in fields such as the physical port number, source and destination MAC address, source and destination IP address, and transmission control protocol/user datagram protocol (TCP/UDP) port number. Note that this flow table may show, for every destination address of the servers 14A, 14B . . . and the terminals 15A, 15B, 15C . . . in the corporate network system 1, a rule of whether to switch to the honey network system 2 or to maintain the current state and not switch to the honey network system 2. The OpenFlow switch 10 executes data transfer, discard, rewriting of destination, and the like on the basis of the set flow table.

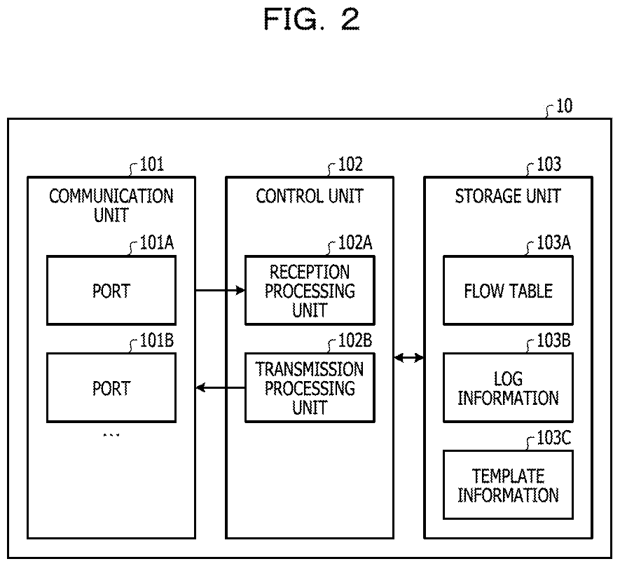

FIG. 2 is a block diagram exemplifying a functional configuration of the communication device according to the embodiment, that is, the OpenFlow switch 10, for example. As illustrated in FIG. 2, the OpenFlow switch 10 includes a communication unit 101, a control unit 102, and a storage unit 103.

The communication unit 101 is a communication interface for performing data communication in packets, under the control of the control unit 102, with devices of the corporate network system 1 and the honey network system 2 (e.g., servers 14A, 14B . . . , and 23A, 23B . . . , terminals 15A, 15B . . . , 22A, 22B . . . , and the like) that are connected through ports 101A, 101B . . . .

The control unit 102 includes a reception processing unit 102A and a transmission processing unit 102B, and controls operation of the OpenFlow switch 10. For example, the control unit 102 controls, based on a flow table 103A stored in the storage unit 103, data transfer, discard, rewriting of destination, and the like between devices connected to the ports 101A, 101B . . . .

The storage unit 103 is a storage device such as a hard disk drive (HDD) and a semiconductor memory, for example. The storage unit 103 stores the flow table 103A delivered from the OpenFlow controller 11, log information 103B collected from each device of the corporate network system 1, preset template information 103C, and the like.

The reception processing unit 102A performs a reception process for receiving packets transmitted by devices connected to the ports 101A, 101B . . . (e.g., terminals 15A, 15B . . . of corporate network system 1, terminals 22A, 22B . . . of honey network system 2, and the like). That is, the reception processing unit 102A is an example of a reception unit.

For example, the reception processing unit 102A receives log information generated by the servers 14A, 14B . . . , which are file servers, mail servers, and the like of the corporate network system 1, and the terminals 15A, 15, 15C . . . , or the like and stores the log information as the log information 103B for each device of the corporate network system 1 in the storage unit 103, for example.

The transmission processing unit 102B refers to the flow table 103A stored in the storage unit 103, and based on the flow table 103A, performs a transmission process for transmitting packets received by the reception processing unit 102A to the destination device (e.g., terminals 15A, 15B, 15C . . . of corporate network system 1, terminals 22A, 22B . . . of honey network system 2, and the like). That is, the transmission processing unit 102B is an example of a transmission unit.

For example, the transmission processing unit 102B outputs (transmits), from the ports 101A, 101B . . . , packets that match a condition described in the flow table 103A by operations described in response to the condition (e.g., passing or blocking of packets, rewriting of MAC address and IP address, and changing of output port).

Additionally, the transmission processing unit 102B selectively changes the destination address of the packet for every destination address based on the rule of the flow table 103A. For example, based on the flow table 103A, the transmission processing unit 102B changes the destination address of the packet whose destination address is assigned a rule to switch to the honey network system 2. Additionally, the transmission processing unit 102B does not change the destination address of the packet whose destination address is assigned a rule to maintain the current state and not switch to the honey network system 2.

Additionally, based on the log information 103B generated in the corporate network system 1, the transmission processing unit 102B performs a transmission process for causing communication such as file transmission and email transmission simulating normal work by humans to occur in the honey network system 2.

For example, based on the log information 103B, the transmission processing unit 102B generates at least one of a fake file of a file related to the corporate network system 1, a fake email of an email related to the corporate network system 1, and fake communication information of communication information related to the corporate network system 1. Note that the transmission processing unit 102B may generate all or any one of the fake file, the fake email, and the fake communication information on the basis of the log information 103B.

Next, the transmission processing unit 102B transmits the generated fake file, fake email, and fake communication information to information processing devices (e.g., servers 23A, 23B . . . , terminals 22A, 22B . . . , and the like) belonging to the honey network system 2.

The NAT router 12 is a router device that converts an IP address or the like and connects networks 13A to 13C in the corporate network system 1 to the external network 3.

The network 13A has the CIDR notation “192.168.1.0/24”, for example, and is a network to which the NAT router 12 in the corporate network system 1 and a NAT router 20 in the honey network system 2 belong. The network 13B has the CIDR notation “192.168.3.0/24”, for example, and is a network to which the servers 14A, 14B . . . in the corporate network system 1 belong.

The network 13C has the CIDR notation “192.168.2.0/24”, for example, and is a network to which the terminals 15A, 15B, 15C . . . in the corporate network system 1 belong. The network 13D has the CIDR notation “192.168.4.0/24”, for example, and is a network to which the OpenFlow controller 11 belongs.

Note that the OpenFlow switch 10 is connected to the terminals 15A, 158, 15C . . . at each port, and is also connected to the network 13D and a network 21B of the honey network system 2 at predetermined ports.

The servers 14A, 14B . . . are server devices such as a web server, a file server, a mail server, or the like belonging to the corporate network system 1. Note that in the following description, the servers 14A, 14B . . . may be referred to as a server 14 unless otherwise specified.

The terminals 15A, 158, 15C . . . are information processing devices such as personal computers (PCs) that belong to the corporate network system 1 and are used by users. That is, the terminals 15A, 15B, 15C . . . are examples of information processing devices belonging to the first system. Note that in the following description, the terminals 15A, 158, 15C . . . may be referred to as a terminal 15 unless otherwise specified.

The honey network system 2 includes the NAT router 20, the terminals 22A, 22B . . . and the servers 23A, 23B . . . .

The NAT router 20 is a router device that converts an IP address or the like and connects the network 13A to networks 21A and 21B in the honey network system 2.

The network 21A has the CIDR notation “192.168.3.0/24”, for example, and is a network to which the servers 23A, 23B . . . in the honey network system 2 belong. The network 21B has the CIDR notation “192.168.2.0/24”, for example, and is a network to which the terminals 22A, 22B . . . . In the honey network system 2 belong.

The terminals 22A, 22B . . . are information processing devices that belong to the honey network system 2 and are prepared corresponding to the terminals 15A, 15B . . . in the corporate network system 1. For example, the terminals 22A, 22B . . . have the same network name and IP address as the respective terminals 15A, 15B in the network 21B of “192.168.2.0/24” similar to the network of the terminals 15A, 158 . . . . For example, the terminal 22A has the same network name and IP address as the terminal 15A, and the terminal 22B has the same network name and IP address as the terminal 15B. Note that the MAC address differs between the terminal 22A and the terminal 15A, and between the terminal 22B and the terminal 15B. Note that while the IPv4 IP addresses are shown as an example, Ipv6 IP addresses can be used in the same manner.

The servers 23A and 23B are server devices that belong to the honey network system 2 and are prepared corresponding to the servers 14A, 14B . . . in the corporate network system 1. Specifically, the servers 23A, 23B . . . have the same network name and IP address as the respective servers 14A, 14B . . . in the network 21A of “192.168.3.0/24” similar to the network of the servers 14A, 14B . . . , for example. For example, the server 23A has the same network name and IP address as the server 14A, and the server 23B has the same network name and IP address as the server 14B. Note that the MAC address differs between the server 23A and the server 14A, and between the server 23B and the server 14B.

As described above, the honey network system 2 is a system imitating the corporate network system 1, where the terminals 22A, 22B . . . of the honey network system 2 respectively imitate the terminals 15A, 15B . . . of the corporate network system 1, and the servers 23A, 23B . . . of the honey network system 2 respectively imitate the servers 14A, 14B . . . of the corporate network system 1.

When the user of the corporate network system 1 (e.g., network administrator) does not detect a terminal 15 infected with malware, the user causes the OpenFlow controller 11 to set, in the OpenFlow switch 10, the flow table 103A that operates in a normal mode in which transmission and reception of packets between the corporate network system 1 and the honey network system 2 are blocked. Hence, in the normal mode, transmission and reception of packets between the corporate network system 1 and the honey network system 2 is blocked by the OpenFlow switch 10.

Note that in this example, it is assumed that a terminal 15 infected with malware is detected by a malware detection program or the like (in the embodiment, terminal 15C is assumed to be infected with malware). In this case, the user causes the OpenFlow controller 11 to set, in the OpenFlow switch 10, the flow table 103A that operates in a deception mode in which packets transmitted and received by the terminal 15C infected with malware are directed to the honey network system 2.

For example, the flow table 103A is set as follows. ⋅For address resolution protocol (ARP) frames from the terminal 22 of the honey network system 2 to the terminal 15C infected with malware, the source MAC address and the source MAC address information in the protocol are rewritten from those of the terminal 22 to those of the terminal 15. ⋅For neighbor discovery protocol (NDP) packets from the terminal 22 of the honey network system 2 to the terminal 15C infected with malware, the source MAC address is rewritten from that of the terminal 22 to that of the terminal 15. In the case of Neighbor Solicitation, the source MAC address information in the protocol is rewritten from that of the terminal 22 to that of the terminal 15. In the case of Neighbor Advertisement, the destination MAC address information in the protocol is rewritten from that of the terminal 22 to that of the terminal 15. ⋅For ARP frames from the NAT router 20 of the honey network system 2 to the terminal 15C infected with malware, the source MAC address and the source MAC address information in the protocol are rewritten from those of the NAT router 20 to those of the NAT router 12. ⋅For NDP packets from the NAT router 20 of the honey network system 2 to the terminal 15C infected with malware, the source MAC address is rewritten from that of the NAT router 20 to that of the NAT router 12. In the case of Neighbor Solicitation, the source MAC address information in the protocol is rewritten from that of the NAT router 20 to that of the NAT router 12. In the case of Neighbor Advertisement, the target MAC address information in the protocol is rewritten from that of the NAT router 20 to that of the NAT router 12. ⋅For ARP frames from the terminal 15C infected with malware to the terminals 15A, 15B . . . , the destination MAC address and the destination MAC address information in the protocol are rewritten from those of the terminal 15 to those of the terminal 22 to transfer (change output port) the ARP frames to the terminals 22A, 22B . . . of the honey network system 2. ⋅ARP frames from the terminal 15C infected with malware to the NAT router 12 are copied and transferred to the NAT router 12 and the OpenFlow switch 10a. ⋅The OpenFlow switch 10a rewrites the destination MAC address and the destination MAC address information in the protocol from those of the NAT router 12 to those of the NAT router 20. ⋅Communication from the terminal 15C infected with malware to the terminals 15A, 15B . . . is transferred (output port is changed) to the terminals 22A, 22B . . . of the honey network system 2. At this time, the destination MAC address is rewritten from that of the terminals 15A, 15B . . . to that of the terminals 22A, 22B . . . . ⋅For communication from the terminal 22 of the honey network system 2 to the terminal 15C infected with malware, the source MAC address is rewritten from that of the terminal 22 to that of the terminal 15. ⋅Communication from the terminal 15C infected with malware to another subnet (e.g., server 14) of the corporate network system 1 is transferred (output port is changed) to the NAT router 20 of the honey network system 2. At this time, the destination MAC address is rewritten from that of the NAT router 12 to that of the NAT router 20. ⋅For communication from a server 23 of the honey network system 2 to the terminal 15C infected with malware, the source MAC address is rewritten from that of the NAT router 20 to that of the NAT router 12. ⋅Communication from the terminal 15C infected with malware to the external network 3 is allowed to pass as it is (communication path is maintained as in normal mode).

As a result, in the deception mode, the OpenFlow switch 10 and the OpenFlow switch 10a isolate the terminal 15C infected with malware in the honey network system 2. For example, without physically transferring the terminal 15C infected with malware from the corporate network system 1 to the honey network system 2, the terminal 15C is logically transferred to the honey network system 2 on the network.

Since the terminal 15C infected with malware is thus isolated in the honey network system 2, it is possible to suppress an attack using the terminal 15C as a platform from spreading to other devices in the corporate network system 1. Accordingly, the user of the corporate network system 1 (e.g., network administrator) can safely monitor the behavior of the terminal 15C infected with malware and safely collect the CTI.

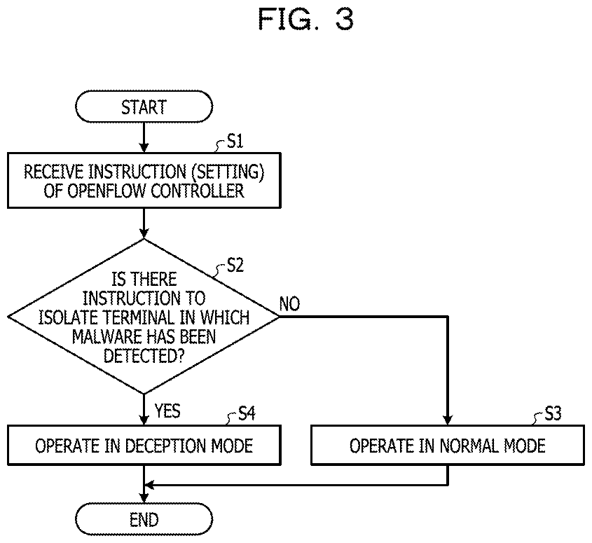

Here, the operation of the OpenFlow switches 10 and 10a will be described in detail. FIG. 3 is a flowchart illustrating an operation example of the communication device (OpenFlow switches 10 and 10a) according to the embodiment. As illustrated in FIG. 3, when the process is started, the control unit 102 receives an instruction (setting) from the OpenFlow controller 11 (S1), and stores the instructed flow table 103A and log information 103B in the storage unit 103.

Note that regarding the setting of the flow table 103A, the flow table 103A corresponding to the normal mode and the flow table 103A for switching to the deception mode for each terminal 15 may be prestored in the storage unit 103. In this case, in S1, an instruction on whether to maintain the normal mode or to switch a predetermined terminal 15 to the deception mode is received.

Next, based on the instruction received in S1, the control unit 102 determines whether or not there is an instruction to isolate the terminal 15 (e.g., terminal 15C) in which malware has been detected (S2).

For example, if the received instruction is the flow table 103A corresponding to the normal mode (S2: NO), the control unit 102 operates in the normal mode with reference to the instructed flow table 103A (S3).

If the received instruction is the flow table 103A corresponding to the deception mode for isolating the terminal 15C infected with malware (S2: YES), the control unit 102 advances the process to S4 and operates in the deception mode with reference to the instructed flow table 103A.

Next, according to the flow table 103A, the control unit 102 operates in the deception mode for rewriting the packets to be rewritten (S4). Here, the control unit 102 may rewrite the destination addresses of packets from the terminal 15C in which malware has been detected, selectively for each destination address on the basis of rules in the log information 103B, to addresses corresponding to the server 23 and the terminals 22A, 22B . . . belonging to the honey network system 2.

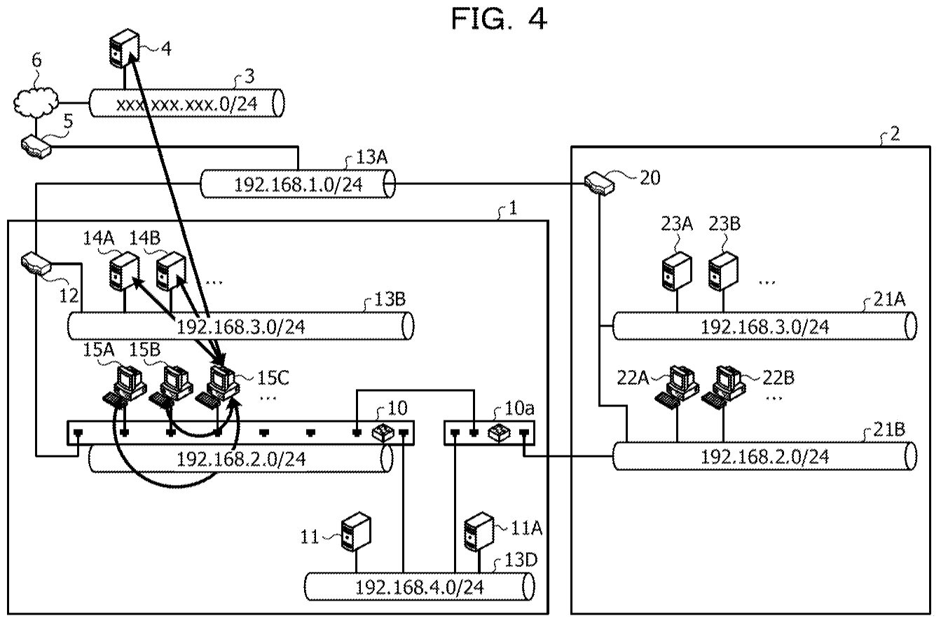

FIG. 4 is an explanatory diagram for explaining communication in the normal mode. As illustrated in FIG. 4, in the normal mode, communication from the terminal 15C to the servers 14A, 14B . . . , the terminals 15A, 15B . . . and the external network 3 is passed, for example.

In the deception mode (S4), for communication from the terminals 22A, 22B . . . of the honey network system 2 and the NAT router 20 to the terminal 15C infected with malware, the OpenFlow switches 10 and 10a rewrite the source MAC address from that of the terminals 22A, 22B . . . and the NAT router 20 to that of the terminals 15A, 15B . . . and the NAT router 12 and transfer the communication to the terminal 15C. In the case of ARP frames, the source MAC address information in the protocol is also rewritten from that of the terminals 22A, 22B . . . and the NAT router 20 to that of the terminals 15A, 15B . . . and the NAT router 12. In the case of NDP packets, for Neighbor Solicitation, the source MAC address information in the protocol is rewritten from that of the terminals 22A, 22B . . . and the NAT router 20 to that of the terminals 15A, 15B . . . and the NAT router 12. For Neighbor Advertisement, the target MAC address information in the protocol is rewritten from that of the terminals 22A, 22B . . . and the NAT router 20 to that of the terminals 15A, 15B . . . and the NAT router 12.

Additionally, the OpenFlow switches 10 and 10a transfer (change output port) communication from the terminal 15C infected with malware to the terminals 15A, 15B . . . to the terminals 22A, 22B . . . of the honey network system 2. At this time, the destination MAC address is rewritten from that of the terminals 15A, 1B . . . to that of the terminals 22A, 22B . . . . In the case of ARP frames, the destination MAC address information in the protocol is also rewritten from that of the terminals 15A, 15B . . . to that of the terminals 22A, 22B . . . .

The OpenFlow switches 10 and 10a copy communication from the terminal 15C infected with malware to the NAT router 12, and transfer the communication to the NAT router 20 of the honey network system 2 (multiple output ports). At this time, the destination MAC address is rewritten from that of the NAT router 12 to that of the NAT router 20. In the case of ARP frames, the destination MAC address information in the protocol is also rewritten from that of the NAT router 12 to that of the NAT router 20.

The OpenFlow switches 10 and 10a transfer communication from the terminal 15C infected with malware to the server 14 to the NAT router 20 of the honey network system 2 (change output port). At this time, the destination MAC address is rewritten from that of the NAT router 12 to that of the NAT router 20. At this time, the destination MAC address is rewritten from that of the NAT router 12 to that of the NAT router 20. As a result, communication from the terminal 15C infected with malware to the server 14 is transferred to the server 23.

Additionally, for communication from the server 23 of the honey network system 2 to the terminal 15C infected with malware, the OpenFlow switches 10 and 10a rewrite the source MAC address from that of the NAT router 20 to that of the NAT router 12, and transmit the communication to the terminal 15C.

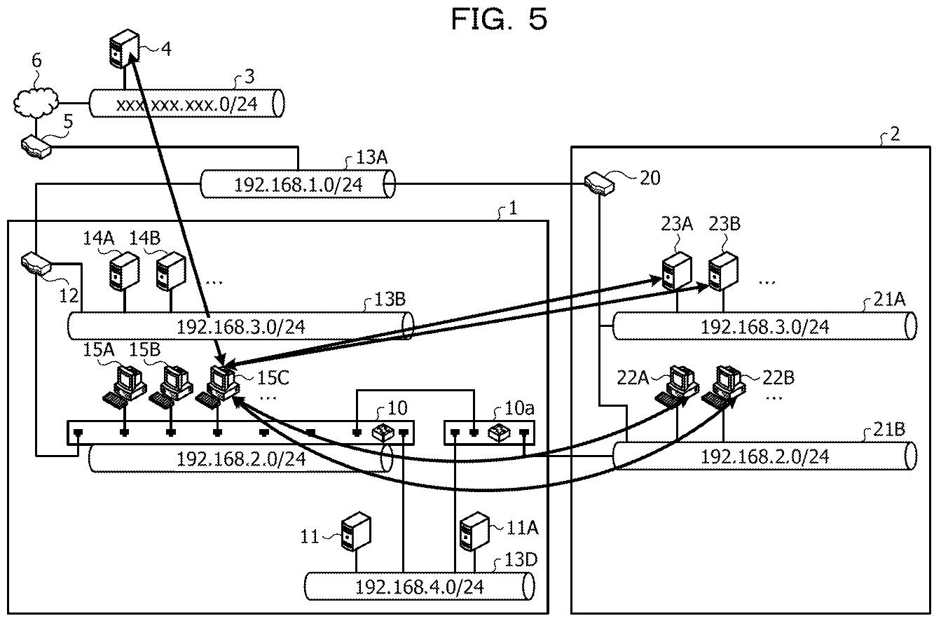

FIG. 5 is an explanatory diagram for explaining communication in the deception mode. As illustrated in FIG. 5, in the deception mode, the terminal 15C infected with malware is logically transferred to the honey network system 2 on the network.

For example, communication from the terminal 15C to the servers 14A, 14B . . . is transferred to the terminals 22A, 22B . . . corresponding to the servers 14A, 14B . . . in the honey network system 2. Communication from the terminal 15C to the terminals 15A, 15B . . . is transferred to the terminals 22A, 22B . . . corresponding to the terminals 15A, 15B . . . in the honey network system 2. Note that communication from the terminal 15C to the external network 3 (e.g., communication to C&C server 4) is allowed to pass as it is.

Next, a description will be given of an operation example of a process in which the transmission processing unit 102B generates and transmits at least one of a fake file, a fake email, and fake communication information, based on the log information 1038 in the deception mode.

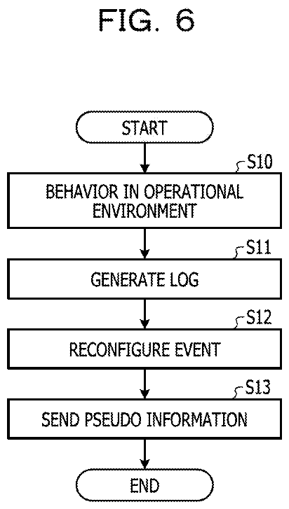

FIG. 6 is a flowchart illustrating an operation example in the deception mode. As illustrated in FIG. 6, in the corporate network system 1, a behavior in the operational environment of the corporate network system 1 such as an operation of the server 14 such as a file server and a mail server and an operation of each terminal of the terminal 15 (S10) generates a log describing the content of the operation (S11).

The reception processing unit 102A receives log information of the server 14 such as a file server and a mail server of the corporate network system 1 and each terminal 15 generated in S11, and stores the log information as the log information 103B for each device of the corporate network system 1 in the storage unit 103.

Next, the transmission processing unit 1028 reconfigures events in the operational environment of the corporate network system 1 based on the log information 103B (S12). For example, event reconfiguration performed by the transmission processing unit 1028 includes generation of a fake file corresponding to a file related to a file server of the corporate network system 1. Event reconfiguration also includes generation of a fake email corresponding to an email related to the mail server. Event reconfiguration also includes generation of fake communication information corresponding to communication information (e.g., communication packet) related to each terminal 15.

As the event reconfiguration by the transmission processing unit 1028, multiple templates for fake files, fake emails, and fake communication information are prepared in advance as template information 103C, and the template information 103C is used. For example, the transmission processing unit 102B reads an event described in the log information 103B such as a file generated by a file server, an email transmitted or received by a mail server, and a communicated communication packet.

Next, the transmission processing unit 102B selects a template corresponding to the read event from the multiple templates in the template information 103C. For example, the transmission processing unit 102B selects a file corresponding to a file name of a file actually generated in the file server of the corporate network system 1, from the file template collection in the file server shown in the template information 103C. Additionally, the transmission processing unit 102B selects an email corresponding to the subject of an email actually transmitted or received by the mail server of the corporate network system 1, from the email template collection in the mail server shown in the template information 103C. Additionally, the transmission processing unit 102B selects a communication packet corresponding to a communication packet actually transmitted or received by each terminal 15 of the corporate network system 1 from the communication packet template collection in each terminal 15 shown in the template information 103C.

Note that for the selection from the template collection in the template information 103C, the transmission processing unit 1028 may use a learning model learned in advance by machine learning or the like.

Next, the transmission processing unit 102B sends the reconfigured data, that is, for example, at least one of a fake file, a fake email, and fake communication information to the honey network system 2 as pseudo information (S13). For example, based on the file generation source, the email transmission and reception destination, the communication packet transmission and reception destination, and the like shown in the log information 1038, the transmission processing unit 102 converts the address to a device of the honey network system 2 corresponding to a destination in the corporate network system 1 and transmits the reconfigured data (pseudo information).

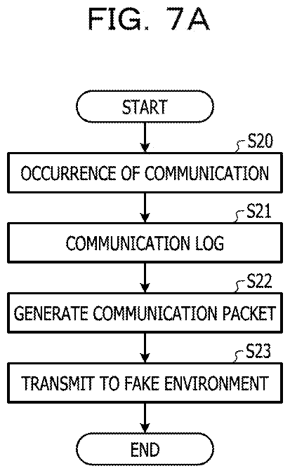

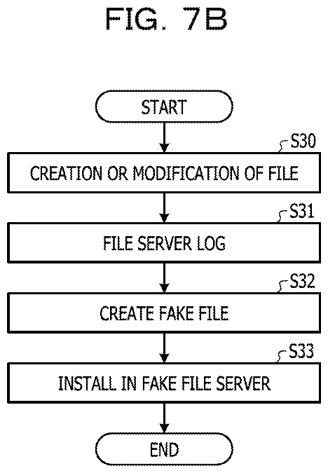

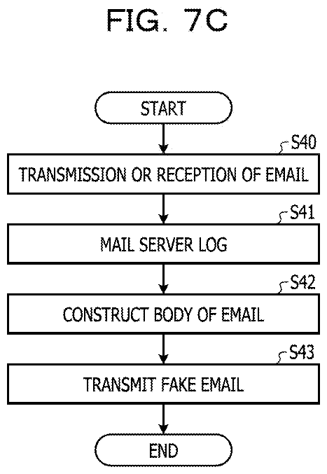

FIGS. 7A to 7C are flowcharts illustrating examples of deceptive communication in the deception mode. Specifically, FIG. 7A is a flowchart exemplifying deceptive communication of a communication packet. Additionally, FIG. 7B is a flowchart exemplifying setting of a fake file in a fake file server in the honey network system 2. Additionally, FIG. 7C is a flowchart exemplifying transmission of a fake email.

First, deceptive communication of a communication packet will be described. As illustrated in FIG. 7A, in the corporate network system 1, when communication of each terminal 15 in the corporate network system 1 occurs (S20), a communication log describing the communication content is generated (S21).

The reception processing unit 102A receives the communication log of each terminal 15 of the corporate network system 1 generated in S21, and stores the communication log in the storage unit 103 as the log information 1038 for each device of the corporate network system 1.

Next, based on the log information 103B, the transmission processing unit 1028 selects a template corresponding to a communication packet actually transmitted or received by each terminal 15 of the corporate network system 1 from a communication packet template collection shown in the template information 103C, and generates a fake communication packet (S22). For example, the transmission processing unit 102B selects, from the template collection, a template whose content is similar to the actually transmitted or received communication packet, and generates a fake communication packet.

Note that the transmission processing unit 1028 may determine encryption or plain text from the communication port shown in the log information 103B, and generate a fake communication packet according to the determined content. For example, in the case of plain text, the transmission processing unit 102B selects a template suitable for the protocol and generates fake communication data (communication packet). Additionally, in the case of encrypted text, the transmission processing unit 102B may use undecryptable random binary as communication data (communication packet).

Next, the transmission processing unit 102B transmits the generated fake communication packet to the fake environment (honey network system 2) (S23).

Next, installation of a fake file in a fake file server will be described. As illustrated in FIG. 7B, in the corporate network system 1, when a file is created or modified in a file server of the corporate network system 1 (S30), a file server log describing the content of the creation or modification of the file is generated (S31).

The reception processing unit 102A receives the file server log of the corporate network system 1 generated in S31, and stores the file server log in the storage unit 103 as the log information 103B related to the file in the file server of the corporate network system 1.

Next, based on the log information 103B, the transmission processing unit 102B selects a template corresponding to the file actually created or modified in the file server of the corporate network system 1 from a file template collection shown in the template information 103C, and generates a fake file (S32). For example, the transmission processing unit 102B selects, from the template collection, a template whose content is similar to the actually created or modified file, and generates a fake file.

For example, when creating a file, the transmission processing unit 102B predicts the content from the file name (including extension) using a learning model or the like, and selects a file template corresponding to the predicted content from the template collection. At this time, the transmission processing unit 102B may supplement some of the contents (e.g., date or the like) in the selected file template according to the current situation. Note that in the case of updating of a file, the transmission processing unit 102B may be configured to only change the time stamp of the file.

Next, the transmission processing unit 102B transmits and installs the generated fake file in a fake file server (file server of honey network system 2 corresponding to file server of corporate network system 1) (533).

Next, transmission of a fake email will be described. As illustrated in FIG. 7C, in the corporate network system 1, when an email is transmitted or received in the mail server of the corporate network system 1 (S40), a mail server log describing the transmission or reception of the email is generated (S41).

The reception processing unit 102A receives the mail server log of the corporate network system 1 generated in S41, and stores the mail server log in the storage unit 103 as the log information 103B related to the email in the mail server of the corporate network system 1.

Next, based on the log information 103B, the transmission processing unit 102B selects a template corresponding to the email actually transmitted or received by the mail server of the corporate network system 1 from an email template collection shown in the template information 103C, and constructs the body of a fake email (542). For example, the transmission processing unit 102B selects, from the template collection, a template whose content is similar to the actually transmitted or received email, and generates a fake email.

For example, the transmission processing unit 102B predicts the content from the subject of the email using a learning model or the like, and selects an email template corresponding to the predicted content from the template collection. At this time, the transmission processing unit 102B may supplement some of the contents (e.g., date or the like) in the selected email template according to the current situation.

Note that the transmission processing unit 102B may construct the body of the fake email through a filter for excluding (converting into another character string) confidential information. With this method, in a case where the subject includes confidential information, for example, the transmission processing unit 102B can generate a fake email after excluding confidential information by the filter.

Next, the transmission processing unit 102B transmits the generated fake email to the transmission or reception destination of the honey network system 2 corresponding to the transmission or reception destination of the email in the corporate network system 1 shown in the log information 103B (S43).

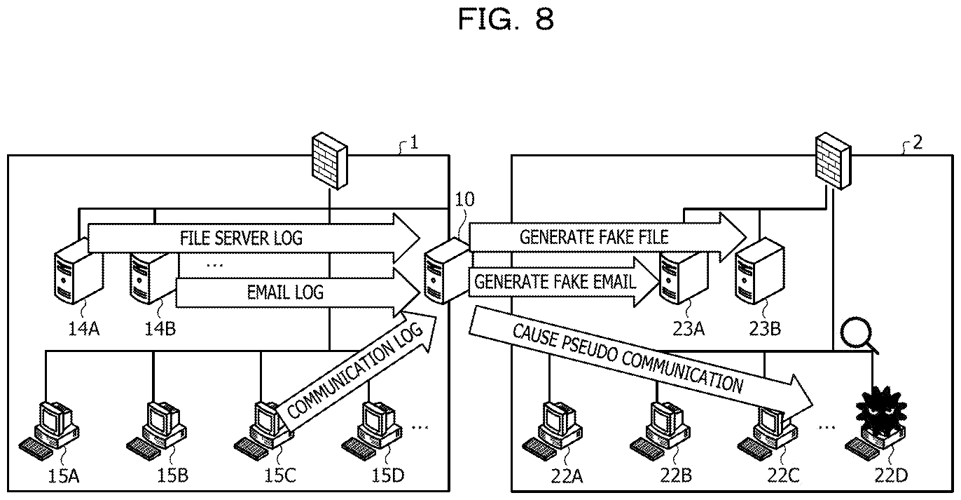

FIG. 8 is an explanatory diagram for explaining deceptive communication in the deception mode. As illustrated in FIG. 8, based on the log information 103B (file server log, email log, communication log, and the like) of the corporate network system 1, the OpenFlow switch 10 generates, in the honey network system 2, a fake file, a fake email, and fake communication information corresponding to the activity of the corporate network system 1. As a result, the user of the corporate network system 1 (e.g., network administrator) can monitor the behavior of the attacker without him/her being aware that he/she is being observed on the honey network system 2.

As described above, the OpenFlow switches 10 and 10a have the communication unit 101 and the transmission processing unit 102B. The communication unit 101 communicates with information processing devices (e.g., servers 14 and 23, and terminals 15 and 22) belonging to the corporate network system 1 or the honey network system 2. When malware is detected in the information processing device (e.g., terminal 15C) belonging to the corporate network system 1, the transmission processing unit 102B changes the destination address of packets transmitted from the information processing device to an address of an information processing device (e.g., server 23 or terminal 22) belonging to the honey network system 2 on the basis of the flow table 103A, and transmits the packets. Additionally, based on the log information 103B generated in the corporate network system 1, the transmission processing unit 102B generates at least one of a fake file of a file related to the corporate network system 1, a fake email of an email related to the corporate network system 1, and fake communication information of communication information related to the corporate network system 1. Next, the transmission processing unit 102B transmits at least one of the generated fake file, fake email, and fake communication information to information processing devices (e.g., server 23 and terminal 22) belonging to the honey network system 2.

As a result, the user of the corporate network system 1 (e.g., network administrator) can isolate packets related to the terminal 15C infected with malware in the corporate network system 1 in the honey network system 2, for example, and suppress the influence of the terminal 15C infected with malware from reaching other devices in the corporate network system 1. Additionally, by generating fake files, fake emails, and fake communication information corresponding to the activity of the corporate network system 1 in the honey network system 2, the user can monitor the behavior of the attacker without him/her being aware that he/she is being observed on the honey network system 2. In this way, the user can safely monitor the behavior of the terminal 15C infected with malware unbeknownst to the attacker, and the CTI can be collected safely.

Additionally, based on the log information 103B generated in a file server belonging to the corporate network system 1, the transmission processing unit 102B generates a fake file of the file of the file server belonging to the corporate network system 1, and transmits the fake file to a file server belonging to the honey network system 2. As a result, a fake file corresponding to the activity of the file server of the corporate network system 1 can also be generated in the file server of the honey network system 2, and it is possible to reproduce a state simulating normal work by humans in the honey network system 2.

The transmission processing unit 102B generates a fake file according to data selected from multiple templates in the template information 103C on the basis of the file name of the file of the file server belonging to the corporate network system 1. As a result, the user can generate a fake file that resembles normal work and that matches the activity of the file server of the corporate network system 1 from the templates prepared in advance.

Additionally, based on the log information 103B generated in a mail server belonging to the corporate network system 1, the transmission processing unit 102B generates a fake email of an email of the mail server belonging to the corporate network system 1, and transmits the fake email to an email server belonging to the honey network system 2. As a result, a fake email corresponding to the activity of the mail server of the corporate network system 1 can also be generated in the mail server of the honey network system 2, and it is possible to reproduce a state simulating normal work by humans in the honey network system 2.

The transmission processing unit 102B generates a fake email according to data selected from multiple templates based on the subject of an email of a mail server belonging to the corporate network system 1. As a result, the user can generate a fake email that resembles normal work and that matches the activity of the mail server of the corporate network system 1 from the templates prepared in advance.

Additionally, based on the log information 103B generated in response to communication in the corporate network system 1, the transmission processing unit 102B generates fake communication information according to data selected from multiple templates based on packets of the communication in the corporate network system 1. As a result, fake communication information corresponding to the communication in the corporate network system 1 can also be generated in the honey network system 2, and it is possible to reproduce a state simulating normal work by humans in the honey network system 2.

Note that the components of each of the illustrated apparatus and devices are not necessarily physically configured as illustrated in the drawings. That is, for example, the specific aspects of separation and integration of each of the apparatus and devices are not limited to the illustrated aspects, and all or some of the apparatus or devices can be functionally or physically separated and integrated in any unit, in accordance with various loads and use status.

Various processing functions performed by the OpenFlow switches 10 and 10a, the OpenFlow controller 11, and the like may be entirely or optionally partially executed on a central processing unit (CPU) (or microcomputer such as microprocessor unit (MPU) or micro controller unit (MCU)). Additionally, it is needless to say that whole or any part of various processing functions may be executed by a program to be analyzed and executed on a CPU (or microcomputer such as MPU or MCU), or on hardware by wired logic.

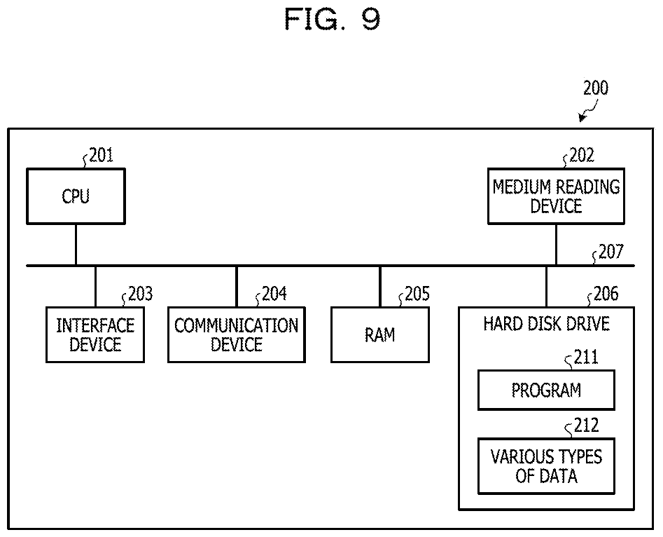

Meanwhile, the various processes described in the above embodiment can be achieved by execution of a prepared program on a computer. Thus, there will be described below an example of a computer (hardware) that executes a program with functions similar to the functions in the above embodiment. FIG. 9 is a block diagram illustrating a hardware configuration example of an information processing device (or communication device such as OpenFlow switch 10) according to an embodiment.

As illustrated in FIG. 9, an information processing device 200 includes a CPU 201 that executes various types of arithmetic processing and a medium reading device 202 that reads a program and the like from a storage medium. Additionally, the information processing device 200 also has an interface device 203 for connecting to various devices and a communication device 204 for connecting and communicating with external devices by wire or wirelessly. Additionally, the information processing device 200 also has a RAM 205 for temporarily storing various types of information, and a hard disk drive 206. Additionally, each unit (201 to 206) in the information processing device 200 is connected to a bus 207.

The hard disk drive 206 stores a program 211 for executing various processes in the reception processing unit 102A, the transmission processing unit 102B, and the like in the control unit 102 described in the above embodiment. Additionally, the hard disk drive 206 stores various types of data 212 to which the program 211 refers. The communication device 204 is connected to networks 13C, 13, 213, and the like such as a local area network (LAN), and exchanges various types of information between devices through the networks 13C, 13D, and 21B.

The CPU 201 performs various processes by reading the program 211 stored in the hard disk drive 206 and loading the program 211 into the RAM 205 to execute the program 211. Note that the program 211 need not be stored in the hard disk drive 206. For example, the program 211 stored in a storage medium readable by the information processing device 200 may be read and executed. Examples of the storage medium readable by the information processing device 200 include a portable recording medium such as a compact disc read only memory (CD-ROM), a digital versatile disc (DVD) disk, and a universal serial bus (USB) memory, a semiconductor memory such as a flash memory, a hard disk drive, and the like. Alternatively, the program 211 may be stored in a device connected to a public line, the Internet, a LAN, or the like, and the information processing device 200 may read the program 211 from the device to execute the program 211.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a generation program that causes a processor to execute a process, the process comprising:
when malware is detected in a first information processing device that belongs to a first system, changing a destination address of packets transmitted from the first information processing device to an address corresponding to a second information processing device that belongs to a second system based on a predetermined rule to transmit the packets to the second information processing device that belongs to the second system;
executing a generation process that, based on log information generated in the first system, generate at least one of a fake file of a file related to the first system, a fake email of an email related to the first system, or fake communication information of communication information related to the first system; and
transmitting the generated fake file or fake communication information to the second information processing device.

2. The non-transitory computer-readable storage medium according to claim 1, wherein the process further comprising:
transmitting the generated fake file or fake communication information to the second information processing device together with the packets.

3. The non-transitory computer-readable storage medium according to claim 1, wherein
the generation process generates a fake file of a file of a file server that belongs to the first system based on log information generated in the file server that belongs to the first system.

4. The non-transitory computer-readable storage medium according to claim 1, wherein
the generation process generates the fake file according to data selected from a plurality of templates based on a file name of a file of a file server that belongs to the first system.

5. The non-transitory computer-readable storage medium according to claim 1, wherein
the generation process generates a fake email of an email of a mail server that belongs to the first system based on log information generated in the mail server that belongs to the first system.

6. The non-transitory computer-readable storage medium according to claim 1, wherein
the generation process generates the fake email according to data selected from a plurality of templates based on a subject of an email of a mail server that belongs to the first system.

7. The non-transitory computer-readable storage medium according to claim 1, wherein
the generation process generates, based on log information generated in response to communication in the first system, the fake communication information according to data selected from a plurality of templates based on packets of the communication.

8. A malware inspection support method executed by a computer, the malware inspection support method comprising:
when malware is detected in a first information processing device that belongs to a first system, changing a destination address of packets transmitted from the first information processing device to an address corresponding to a second information processing device that belongs to a second system based on a predetermined rule to transmit the packets to the second information processing device that belongs to the second system;
based on log information generated in the first system, generating at least one of a fake file of a file related to the first system, a fake email of an email related to the first system, or fake communication information of communication information related to the first system; and
transmitting the generated fake file, fake email, or fake communication information to the second information processing device.

9. The malware inspection support method according to claim 8, wherein
the generating includes generating a fake file of a file of a file server that belongs to the first system based on log information generated in the file server that belongs to the first system.

10. The malware inspection support method according to claim 8, wherein
the generating includes generating the fake file according to data selected from a plurality of templates based on a file name of a file of a file server that belongs to the first system.

11. The malware inspection support method according to claim 8, wherein
the generating includes generating a fake email of an email of a mail server that belongs to the first system based on log information generated in the mail server that belongs to the first system.

12. The malware inspection support method according to claim 8, wherein
the generating includes generating the fake email according to data selected from a plurality of templates based on a subject of an email of a mail server that belongs to the first system.

13. The malware inspection support method according to claim 8, wherein
the generating includes generating, based on log information generated in response to communication in the first system, the fake communication information according to data selected from a plurality of templates based on packets of the communication.

14. An apparatus, comprising:
a communicator configured to communicate with an information processing device that belongs to a first system or a second system; and
a processor configured to:
when malware is detected in a first information processing device that belongs to the first system, change a destination address of packets transmitted from the first information processing device to an address corresponding to a second information processing device that belongs to the second system based on a predetermined rule to transmit the packets to the second information processing device that belongs to the second system, and
also configured to, based on log information generated in the first system, generate at least one of a fake file of a file related to the first system, a fake email of an email related to the first system, or fake communication information of communication information related to the first system, wherein
the communicator transmits the generated fake file, fake email, or fake communication information to the second information processing device.

15. The apparatus according to claim 14, wherein
the processor generates a fake file of a file of a file server that belongs to the first system based on log information generated in the file server that belongs to the first system, and transmits the fake file to a file server that belongs to the second system.

16. The apparatus according to claim 14, wherein
the processor generates the fake file according to data selected from a plurality of templates based on a file name of a file of a file server that belongs to the first system.

17. The apparatus according to claim 14, wherein
the processor generates a fake email of an email of a mail server that belongs to the first system based on log information generated in the mail server that belongs to the first system, and transmits the fake email to a mail server that belongs to the second system.

18. The apparatus according to claim 14, wherein
the processor generates the fake email according to data selected from a plurality of templates based on a subject of an email of a mail server that belongs to the first system.

19. The apparatus according to claim 14, wherein
the processor generates, based on log information generated in response to communication in the first system, the fake communication information according to data selected from a plurality of templates based on packets of the communication.
